(19) United States
(12) Patent Application Publication
(10) Pub. No.: US 2021/0264347 A1
(43) Pub. Date: Aug. 26, 2021

(54) PRODUCT CYCLE MANAGEMENT

(71) Applicant: INTERNATIONAL BUSINESS MACHINES CORPORATION, Armonk, NY (US)

(72) Inventors: Erin Marlana Farr, Fishkill, NY (US); Sudha Dhanwada, Tenafly, NJ (US); Patricia G. Driever, Poughkeepsie, NY (US); Shin Yang, Poughkeepsie, NY (US)

(21) Appl. No.: 16/801,991

(22) Filed: Feb. 26, 2020

(51) Int. Cl. G06Q 10/08; G06Q 30/02; G06F 17/16

(52) U.S. Cl. CPC G06Q 10/087; G06F 17/16; G06Q 30/0226

(57) ABSTRACT

A method, computer system, and a computer program product for product cycle management is provided. The present invention may include storing, in an inventory database, a batch-related information for a corresponding batch of products. The stored batch-related information may include a batch date assigned to the corresponding batch of products. The present invention may also include detecting a consumer identifier (ID) in a purchase transaction for a product of the corresponding batch of products. The present invention may further include recording the purchase transaction for the product with the detected consumer ID. The present invention may also include transmitting, to a device associated with the detected consumer ID, the batch date linked to the product of the corresponding batch of products.

### BACKGROUND

The present invention relates generally to the field of computing, and more particularly to time-sensitive product cycle management.

Consumers in North America and Europe alone waste approximately 209 to 253 pounds of food, per person, every year. Inventory management of time-sensitive, perishable products is currently a manual process. Retailers employ staff to stock shelves with older items in the front, and manually check for expired products. Such work is inefficient, labor-intensive, and error-prone. Additionally, consumers have to rely on their memory or manual tracking to avoid food waste.

### SUMMARY

Embodiments of the present invention disclose a method, computer system, and a computer program product for product cycle management. The present invention may include storing, in an inventory database, a batch-related information for a corresponding batch of products. The stored batch-related information may include a batch date assigned to the corresponding batch of products. The present invention may also include detecting a consumer identifier (ID) in a purchase transaction for a product of the corresponding batch of products. The present invention may further include recording the purchase transaction for the product with the detected consumer ID. The present invention may also include transmitting, to a device associated with the detected consumer ID, the batch date linked to the product of the corresponding batch of products.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is a block diagram of a supply chain environment according to at least one embodiment;

FIG. 3 is an operational flowchart illustrating a process for product cycle management according to at least one embodiment;

FIG. 4 is a diagram illustrating an exemplary product cycle management process used by a product cycle management program according to at least one embodiment;

FIG. 5 is a block diagram of internal and external components of computers and servers depicted in FIG. 1 according to at least one embodiment;

FIG. 6 is a block diagram of an illustrative cloud computing environment including the computer system depicted in FIG. 1, in accordance with an embodiment of the present disclosure; and

FIG. 7 is a block diagram of functional layers of the illustrative cloud computing environment of FIG. 6, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, Python, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product for managing the lifecycle of perishable consumer products. As such, the present embodiment has the capacity to improve the technical field of product cycle management by providing a means for a consumer to utilize a retailer's inventory data to identify which products purchased by the consumer are approaching a product expiration date. More specifically, a batch-related information for a corresponding batch of products may be imported from a machine-readable label. The imported batch-related information may include a batch date assigned to the corresponding batch of products. Then, the imported batch-related information may be stored in an inventory database. Next, a consumer identifier (ID) linked to the retailer may be detected during a purchase transaction for a product. Then, the purchase transaction may be recorded with a consumer account associated with the consumer ID. Thereafter, a batch date (e.g., expiration date) linked to the purchased product may be transmitted to a device associated with the consumer ID.

As described previously, consumers in North America and Europe alone waste approximately 209 to 253 pounds of food, per person, every year. Inventory management of time-sensitive, perishable products is currently a manual process. Retailers employ staff to stock shelves with older items in the front, and manually check for expired products. Such work is inefficient, labor-intensive, and error-prone. Additionally, consumers have to rely on their memory or manual tracking to avoid food waste.

Therefore, it may be advantageous to, among other things, provide for an automatic flow of date information for perishable products from a manufacturer, through a retailer, to a consumer, such that the retailer and consumer may electronically track and identify which products are approaching an expiration date or the end of a usefulness period.

According to at least one embodiment, a consumer may utilize a retailer's existing inventory information to identify which items are approaching their expiration date. In one embodiment, the retailer may include an inventory system configured to track product expiration dates. In one embodiment, a consumer loyalty card may be used to associate a consumer's purchases with the product's expiration information.

According to various embodiments, a batch date assigned to a corresponding batch of products may be encoded in a machine-readable code affixed to each product of the corresponding batch of products. The encoded batch date may include an expiration date of each product in the corresponding batch of products. In one embodiment, decoding the machine-readable code affixed to a single product of the corresponding batch of products may import the expiration date of each product of the corresponding batch of products into the retailer's inventory system.

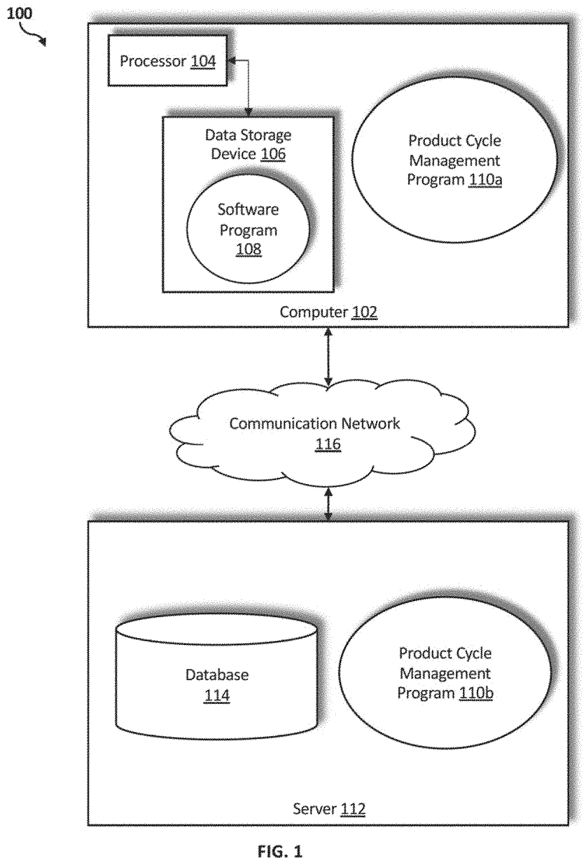

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a product cycle management (PCM) program 110a. The networked computer environment 100 may also include a server 112 that is enabled to run a PCM program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

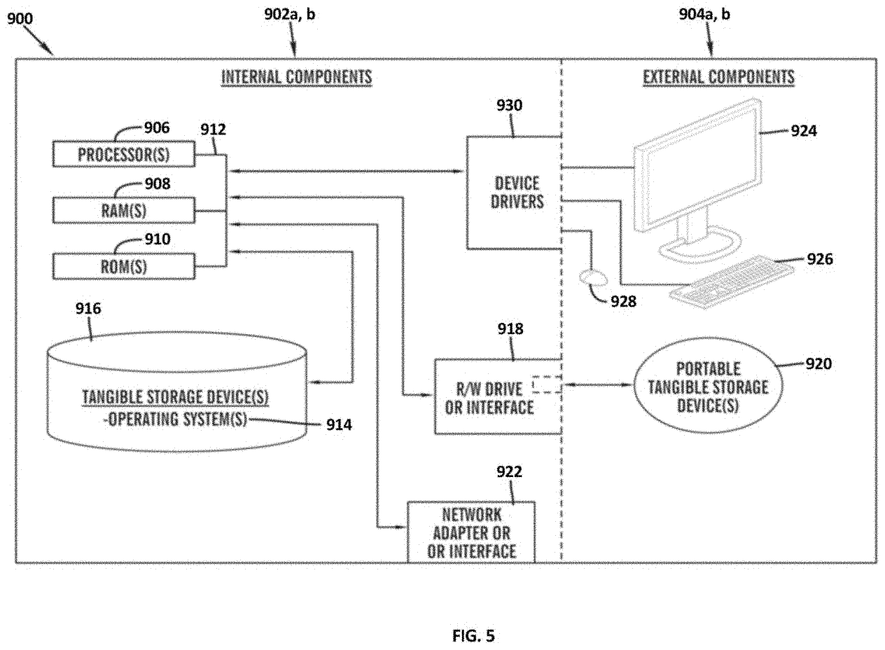

The client computer 102 may communicate with the server computer 112 via the communications network 116. The communications network 116 may include connections, such as wire, wireless communication links, or fiber optic cables. As will be discussed with reference to FIG. 5, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the PCM program 110a, 110b may interact with a database 114 that may be embedded in various storage devices, such as, but not limited to a computer/mobile device 102, a networked server 112, or a cloud storage service.

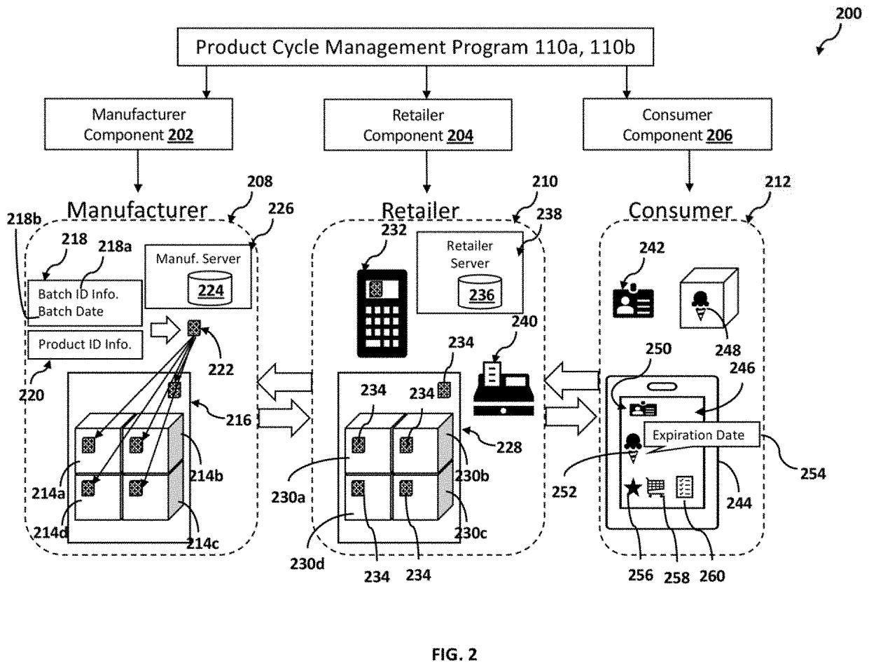

Referring now to FIG. 2, a diagram of a supply chain environment 200 in which the product cycle management (PCM) program 110a, 110b may be implemented according to at least one embodiment is depicted.

According to one embodiment, the supply chain environment 200 may comprise a networked computer environment, similar to the networked computer environment 100 described with reference to FIG. 1. Therefore, the supply chain environment 200 may include one or more client computers (e.g., client computer 102), one or more server computers (e.g., server computer 112), and one or more storage devices (e.g., data storage device 106; database 114) linked through a communication network (e.g., communication network 116).

The PCM program 110a, 110b running in the networked computer environment of the supply chain environment 200 may include a single computer program or multiple program modules or sets of instructions being executed by one or more processors of the networked computer environment. The PCM program 110a, 110b may be practiced in distributed cloud computing environments where tasks are performed by remote processing devices that may be linked through the communication network described above. In one embodiment, the PCM program 110a, 110b may include program instructions that may be collectively stored on one or more computer-readable storage media. The PCM program 110a, 110b may include routines, objects, components, units, logic, data structures, and actions that may perform particular tasks or implement particular abstract data types.

According to one embodiment, the PCM program 110a, 110b may enable time-sensitive date information, for perishable products, to automatically flow from a manufacturer to consumers, by leveraging a retailer's inventory control system. In various embodiments, the PCM program 110a, 110b may automatically notify consumers regarding expiration dates, best-by dates, or use-by dates, for products purchased by the consumers. In some embodiments, the PCM program 110a, 110b may provide additional functionalities for consumers, such as, suggesting recipes and other uses for products purchased by the consumers and generating shopping lists to replenish products purchased by the consumers. The PCM program 110a, 110b may also provide value to a retailer by enabling the retailer to track the time-sensitive date information, for perishable products, using the retailer's inventory control system. In at least some embodiment, the PCM program 110a, 110b may provide a feedback loop between consumers and retailers/manufacturers, which may influence future purchase decisions by the retailers and future product improvements by the manufacturer.

The PCM program 110a, 110b may include a manufacturer component 202, a retailer component 204, and a consumer component 206. According to various embodiments, the manufacturer component 202 may be implemented to provide functionalities for one or more manufacturer operations 208, the retailer component 204 may be implemented to provide functionalities for one or more retailer operations 210, and the consumer component 206 may be implemented to provide functionalities for one or more consumer operations 212.

According to one embodiment, the manufacturer operations 208 may include producing products 214a-214d, which may be time-sensitive and perishable. Products 214a-214d created within a specified time range may be organized as a batch 216, where the products 214a-214d in the batch 216 may include the same batch date (e.g., expiration date, best if used by date, packaging date, or some other suggested freshness/effectiveness date).

Manufacturers typically imprint this time-sensitive product/batch date information on packaging using ink stamps, stickers, or similar methods which require manual tracking. Accordingly, embodiments of the present disclosure enable encoding the time-sensitive product/batch date information on packaging in a manner in which the date information may be scanned and imported into a tracking system for automatic tracking by retailers and consumers.

According to one embodiment, the PCM program 110a, 110b may enable the manufacturer to encode a batch-related information 218 and a product-related information 220 into a machine-readable symbol or code 222. In one embodiment, the batch-related information 218 may include a batch identifying (ID) number 218a and a batch date 210b (e.g., expiration date, best if used by date, packaging date, or some other suggested freshness/effectiveness date). In one embodiment, the product-related information 220 may include a product ID number (e.g., universal product code) which may be used to look up additional information regarding the product (e.g., description, size, weight, price) in an associated database.

In one embodiment, the batch-related information 218 and the product-related information 220 may be encoded into a single machine-readable code 222, as illustrated in FIG. 2. In such embodiments, the machine-readable code 222 may include a matrix barcode (or two-dimensional (2-D) barcode) configured to store thousands of alphanumeric characters. By encoding the batch-related information 218 and the product-related information 220 into one matrix barcode type machine-readable code 222, a single scan of a product may return both the batch-related information 218 (e.g., expiration date) and product-related information 220. In various embodiments, matrix barcodes which may be implemented with the PCM program 110a, 110b include, for example, a GS1® (GS1 and all GS1-based trademarks and logos are trademarks or registered trademarks of GS1 AISBL and/or its affiliates) barcode standard (e.g., GS1 DataMatrix) or QR Code® (QR Code and all QR Code-based trademarks and logos are trademarks or registered trademarks of Denso Wave Inc. and/or its affiliates). Although not specially shown in the FIG. 2, in some embodiments, the batch-related information 218 and the product-related information 220 may be encoded into separate machine-readable codes 222. In such embodiments, the batch-related information 218 may be encoded into a matrix barcode (e.g., GS1 DataMatrix or QR Code) and the product-related information 220 may be encoded into a one-dimensional barcode (e.g., UPC code).

As illustrated in FIG. 2, in one embodiment, machine-readable code 222 encoded with both the batch-related information 218 and the product-related information 220 may be affixed to each of the products 214a-214d and the packaging of the batch 216. As a result, any of the machine-readable codes 222 affixed to any of the products 214a-214d or the packaging of batch 216 may be scanned to return the batch date 218b for all of the products 214a-214d in the batch 216.

During the manufacturer operations 208, the manufacturer may generate a record of the batch-related information 218, the product-related information 220, and the machine-readable codes 222 embedded with the corresponding batch-related information 218 and product-related information 220. In one embodiment, the manufacturer may store this record in a database 224 associated with a manufacturer server 226. In one embodiment, the database 224 may associate the machine-readable code 222 with a particular batch 216, and further with the corresponding batch-related information 218 and product-related information 220. The manufacturer record stored in the database 224 may be transmitted to the retailer and used by the retailer during the retailer operations 210, as discussed below.

As shown in FIG. 2, the retailer operations 210 includes a received batch 228 of products 230a-230d. In one embodiment, the received batch 228 of products 230a-230d includes the batch 216 of products 214a-214d shipped from the manufacturer. After receiving the shipment from the manufacturer, the retailer may implement a scanner 232 to sense (e.g., read, decode) a machine-readable code 234 (e.g., may include machine-readable code 222) associated with (e.g., affixed) the received batch 228. The scanner 232 may include an optical scanner (e.g., barcode reader) or a mobile device with a camera running an application software configured to read the machine-readable code 234. In one embodiment, the retailer may perform a one time scan (e.g., scan the machine-readable code 234 on product 230b) using the scanner 232 to import the batch and product-related information (e.g., including the batch date) for all the products 230a-230d into an inventory database 236 (e.g., inventory control system) of a retailer server 238. In one embodiment, the retailer may use the machine-readable code 234 to access additional batch/product-related information in the manufacturer record transmitted by the manufacturer. The retailer may store the additional batch/product-related information linked to the machine-readable code 234 in the inventory database 236. In one embodiment, the retailer operations 210 may include a point of sale (POS) system 240. In some embodiments, the POS system 240 may include checkout stations operated by staff of the retailer. In other embodiments, the POS system 240 may include self-checkout stations operated by the consumer. As will be further detailed below, the POS system 240 may be linked (e.g., via communication network 116) to communicate with the inventory database 236 for processing purchase transactions.

Turning now to the consumer operations 212, a consumer may interact with the POS system 240 of the retailer to purchase one or more products 230a-230d. During the purchase transaction, the machine-readable code 234 of the product 230a-230d being purchased by the consumer may be scanned using the POS system 240. In one embodiment, the POS system 240 may use the machine-readable code 234 to look up the price of the product 230a-230d in the inventory database 236 and process a payment. In one embodiment, processing the payment for a quantity of the products 230a-230d may trigger the inventory database 236 to remove that quantity from a current stock of the products 230a-230d.

In one embodiment, the purchase transaction may include the consumer providing a consumer ID 242 to trigger linking or recording the purchase history with a consumer account or profile with the retailer (e.g., profile registered with retailer-based loyalty program). In one embodiment, the consumer ID 242 may include a physical loyalty card with identifying information configured to identify the consumer profile with the retailer server 238. In other embodiments, the consumer ID 242 may include a consumer account number, the consumer's electronic mail (E-mail) address, and/or the consumer's telephone number. Once the purchase transaction is completed, the retailer server 238 may record the purchase transaction for the product 230a-230d with the consumer ID.

According to one embodiment, the PCM program 110a, 110b may enable the consumer to access the recorded purchase transaction using a device 244 associated with the consumer ID 242. In one embodiment, the PCM program 110a, 110b may provide a consumer application 246 (e.g., mobile phone application) which links to the inventory database 236 of the retailer server 238 to receive one or more data about a purchased product 248. In one embodiment, the consumer may log into the consumer application 246 using the consumer ID 242 to identify the consumer with the retailer server 238. In one embodiment, the consumer application 246 may enable the consumer to access a transaction history 250 associated with the consumer ID 242. The transaction history 250 may list one or more records 252 of purchased products 248 linked to the consumer ID 242 by the retailer server 238. In one embodiment, the transaction history 250 may provide the consumer with access to all the data embedded in the machine-readable code 234 of the purchased product 248 and stored in the inventory database 236. Specifically, the consumer application 246 may provide the consumer with access to the batch-related information 218 and product-related information 220 for each purchased product 248. In one embodiment, the batch-related information 218 may include the batch date 218b information, such as, the expiration date, best-by date, use-by date, or sell-by date of the purchased product 248. In one embodiment, the retailer server 238 may transmit a signal to the consumer application 246 to generate a notification 254 indicating that the purchased product 248 is approaching the expiration date, best-by date, or use-by date.

According to some embodiments, the consumer application 246 may include a feedback component 256, a shopping list component 258, and a recipe component 260. In one embodiment, the consumer may interact with the feedback component 256 to provide feedback for the manufacturer operations 208 and/or the retailer operations 210. In one embodiment, the feedback component 256 may direct the consumer to a product rating or loyalty member website where the consumer may enter ratings for purchased products 248. In one embodiment, the retailer may access the consumer feedback on the purchased products to influence future purchases from the manufacturer. In one embodiment, the manufacturer may also access the consumer feedback to determine improvements for future product iterations. In one embodiment, the consumer may interact with the shopping list component 258 to maintain a list of products which need to be purchased. The shopping list component 258 may enable the consumer to recall the list of products when the consumer is shopping at the retailer. The consumer may interact with the recipe component 260 to receive suggested recipes using the purchased products 248. In one embodiment, the recipe component 260 may enable the consumer to select the products to be used when generating the suggested recipe. In one embodiment, the suggested recipe may be provided within the consumer application 246 or the consumer may be directed to recipe website from the consumer application 246.

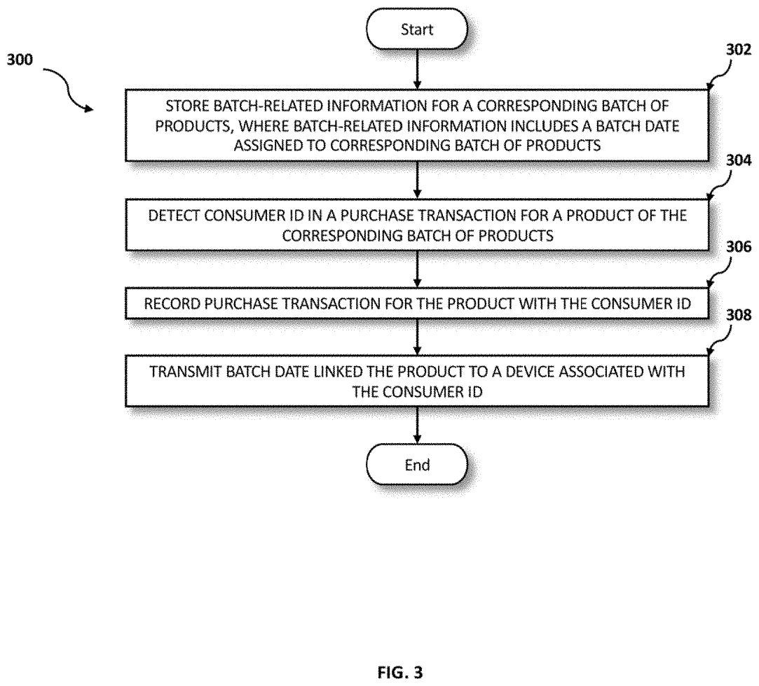

According to the present embodiment, a user using a client computer 102 or a server computer 112 may use the product cycle management (PCM) program 110a, 110b (respectively) and an inventory control system to automatically transmit time-sensitive date information from a manufacturer of a product to a consumer of the product. The PCM method is explained in more detail below with respect to FIG. 3.

Referring now to FIG. 3, an operational flowchart illustrating an exemplary PCM process 300 used by the PCM program 110a and 110b according to at least one embodiment is depicted.

At 302, batch-related information for a corresponding batch of products is stored, where the batch-related information includes a batch date assigned to the corresponding batch of products. As described with reference to FIG. 2, a manufacturer may encode batch-related information and product-related information associated with a batch of products in a machine-readable code. In one embodiment, the batch-related information may include a batch date, such as, for example, an expiration date, a best-by date, a use-by date, or sell-by date. The manufacturer may attach the machine-readable code to the products in the batch of products before shipping the product to the retailer. The machine-readable code may include a one-dimensional barcode, a two-dimensional barcode, or any encoded image which may be scanned and processed (e.g., via image analysis) to decode the stored information. In at least one embodiment, the machine-readable code may include a radio-frequency identification (RFID) tag configured to store the batch-related information and product-related information. Upon receiving the batch of products from the manufacturer, the retailer may implement the PCM program 110a, 110b to import the batch-related information.

In one embodiment, the retailer may use a scanner (e.g., barcode reader; mobile device running an application software configured to read the machine-readable code) to read or decode the machine-readable code associated with the received batch of products. The scanner may detect the batch-related information for the corresponding batch of products encoded in the machine-readable code on a packaging of at least one product of the corresponding batch of products. In one embodiment, the retailer may perform a one-time scan using the scanner to import the batch and product-related information (e.g., including the batch date) for all the products of the batch of products into an inventory database 236 (e.g., inventory control system) of a retailer server.

Then at 304, a consumer ID is detected in a purchase transaction for a product of the corresponding batch of products. According to one embodiment, the PCM program 110a, 110b may enable a consumer to access a record of a purchase transaction by linking a consumer ID with the purchase transaction. After detecting the consumer ID, the PCM program 110a, 110b may record the purchase history with a consumer account or profile with the retailer (e.g., retailer-based loyalty program). In one embodiment, the consumer ID may include a physical loyalty card with identifying information configured to identify the consumer profile with the retailer server. In other embodiments, the consumer ID may include a consumer account number, the consumer's E-mail address, and/or the consumer's telephone number.

Then at 306, the purchase transaction for the product is recorded with the consumer ID. In one embodiment, the PCM program 110a, 110b may enable the consumer to access the inventory database of the retailer server, using the consumer ID, to receive one or more data about a purchased product. In one embodiment, the PCM program 110a, 110b may enable the retailer to record the products purchased by the consumer in a transaction history associated with the consumer ID. The transaction history may list one or more records of purchased products linked to the consumer ID by the retailer server. In one embodiment, the transaction history may provide the consumer with access to all the data embedded in the machine-readable code of the purchased product and stored in the inventory database. In one embodiment, after the purchase transaction is completed, an instance of the product may be removed from a current stock in the inventory database.

Then at 308, the batch date linked to the product is transmitted to the device associated with the consumer ID. As previously noted, the PCM program 110a, 110b may provide a consumer application (e.g., mobile phone application) which may link to the inventory database of the retailer server to transmit one or more data about a purchased product. In one embodiment, the consumer application may provide the consumer with access to the batch-related information and product-related information for each purchased product recorded with the consumer ID. In one embodiment, the batch-related information may include the batch date information, such as, the expiration date, best-by date, use-by date, or sell-by date of the purchased product. In one embodiment, the retailer server may automatically transmit a signal to the consumer application indicating that a purchased product is approaching a expiration date, best-by date, or use-by date.

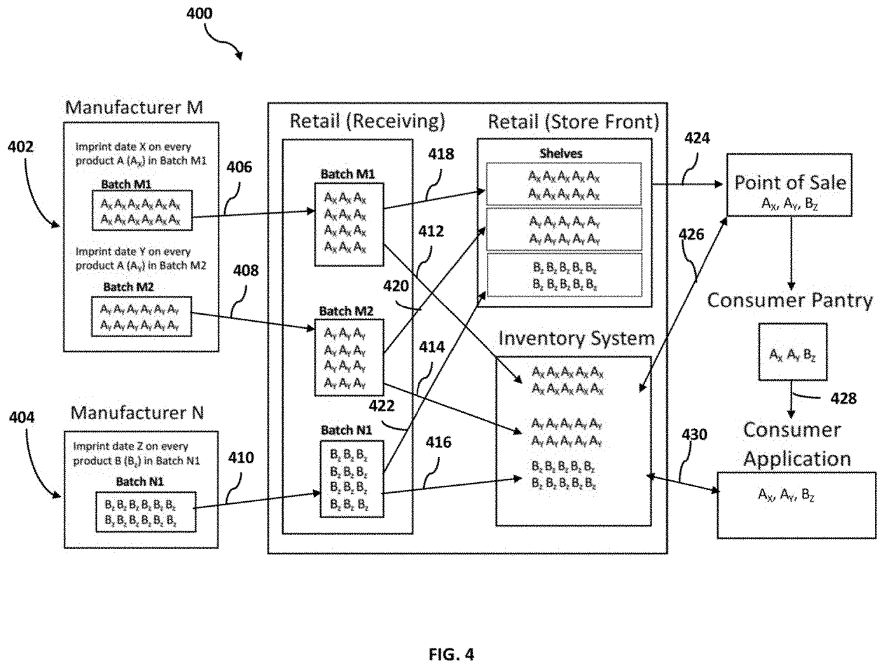

Referring now to FIG. 4, a diagram 400 illustrating an exemplary PCM process used by the PCM program 110a, 110b according to at least one embodiment is depicted.

As shown in FIG. 4, a manufacturer M produces a first batch M1 of products A and a second batch M2 of products A, where both batch of products may be subject to expiration. In one embodiment, the first batch M1 may include products A produced within a first specified time range and the second batch M2 may include products A produced within a second specified time range. In one embodiment, manufacturer M may calculate an expiration date X for batch M1 and an expiration date Y for batch M2. Accordingly, at event 402, the manufacturer M may imprint date X on every product A (“Aₓ”) in batch M1 and date Y on every product A (“A_{y}”) in batch M2. In one embodiment, imprinting the dates on every product may include encoding a machine-readable code on every product with the batch date, as described previously. Similarly, a manufacturer N produces a third batch N1 of products B that may be subject to expiration. At event 404, the manufacturer N may encode date Z in a machine-readable code on every product B (“B_{z}”) in batch N1.

Then at event 406, a retailer may receive a shipment of batch M1 from manufacturer M. Similarly, at event 408, the retailer may receive a shipment of batch M2 from manufacturer M and at event 410, the retailer may receive a shipment of batch N1 from manufacturer N.

After receiving batch M1, at event 412, the retailer may scan the machine-readable code on a single product Aₓ of batch M1. As a result, the date information X for the batch M1 may be imported from the machine-readable code and stored in an inventory system of the retail store. Similarly, at event 414, the date information Y for the batch M2 may be imported from the machine-readable code on a single product A_{Y} and stored in the inventory system of the retail store. Further, at event 416, the date information Z for the batch N1 may be imported from the machine-readable code on a single product B_{Z} and stored in the inventory system of the retail store. Thereafter, at events 418, 420, and 422, products A_{X}, A_{Y}, and B_{Z}, respectively, may be stocked in the shelves of the retail store front.

Then at event 424, a consumer may interact with a POS system to purchase products A_{X}, A_{Y}, and B_{Z}. The POS system may scan the machine-readable codes on each product A_{X}, A_{Y}, and B_{Z} to process the transaction. In one embodiment, the consumer may provide a retail store loyalty card during the purchase transaction at event 424. In response, the inventory system may record the purchased products A_{X}, A_{Y}, and B_{Z} with a consumer ID associated with the loyalty card. Further, at event 426, the inventory system may remove instances of products A_{X}, A_{Y}, and B_{Z} from the current stock in the inventory system when the machine-readable codes on each product are scanned at the POS system.

Then at event 428, the consumer may interact with a consumer application to access the date information assigned to the purchased products A_{X}, A_{Y}, and B_{Z}. At event 430, the consumer application may communicate with the inventory system to receive the date information X, Y, Z for products A_{X}, A_{Y}, and B_{Z}, respectively.

The functionality of a computer may be improved by the PCM program 110a, 110b because the PCM program 110a, 110b may enable a computer to transmit time-sensitive date information, for perishable products, from a manufacturer to consumers, by leveraging a retailer's inventory control system. In various embodiments, the PCM program 110a, 110b may use a computer to automatically notify consumers regarding expiration dates, best-by dates, or use-by dates, for products purchased by the consumers. In some embodiments, the PCM program 110a, 110b may enable a computer to provide additional functionalities for consumers, such as, suggesting recipes and other uses for products purchased by the consumers and generating shopping lists to replenish products purchased by the consumers. The PCM program 110a, 110b may also enable a computer to provide value to a retailer by enabling the retailer to track the time-sensitive date information, for perishable products, using the retailer's inventory control system. In at least some embodiment, the PCM program 110a, 110b may enable a computer to transmit feedback from the consumers to retailers and manufacturers.

It may be appreciated that FIGS. 2 to 4 provide only an illustration of one embodiment and do not imply any limitations with regard to how different embodiments may be implemented. Many modifications to the depicted embodiment(s) may be made based on design and implementation requirements.

FIG. 5 is a block diagram 900 of internal and external components of computers depicted in FIG. 1 in accordance with an illustrative embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902a, b and external components 904a, b illustrated in FIG. 5. Each of the sets of internal components 902a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the PCM program 110a in client computer 102, and the PCM program 110b in network server 112, may be stored on one or more computer-readable tangible storage devices 916 for execution by one or more processors 906 via one or more RAMs 908 (which typically include cache memory). In the embodiment illustrated in FIG. 5, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the PCM program 110a and 110b can be stored on one or more of the respective portable computer-readable tangible storage devices 920, read via the respective R/W drive or interface 918 and loaded into the respective hard drive 916.

Each set of internal components 902a, b may also include network adapters (or switch port cards) or interfaces 922 such as a TCP/IP adapter cards, wireless wi-fi interface cards, or 3G or 4G wireless interface cards or other wired or wireless communication links. The software program 108 and the PCM program 110a in client computer 102 and the PCM program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the PCM program 110a in client computer 102 and the PCM program 110b in network server computer 112 are loaded into the respective hard drive 916. The network may comprise copper wires, optical fibers, wireless transmission, routers, firewalls, switches, gateway computers and/or edge servers.

Each of the sets of external components 904a, b can include a computer display monitor 924, a keyboard 926, and a computer mouse 928. External components 904a, b can also include touch screens, virtual keyboards, touch pads, pointing devices, and other human interface devices. Each of the sets of internal components 902a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

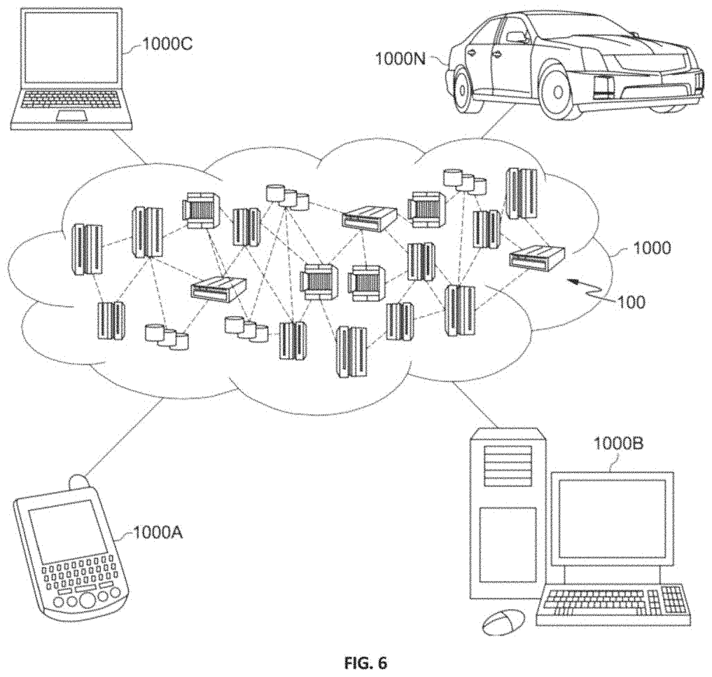

Referring now to FIG. 6, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 6 are intended to be illustrative only and that computing nodes 100 and cloud computing environment 1000 can communicate with any type of computerized device over any type of network and/or network addressable connection (e.g., using a web browser).

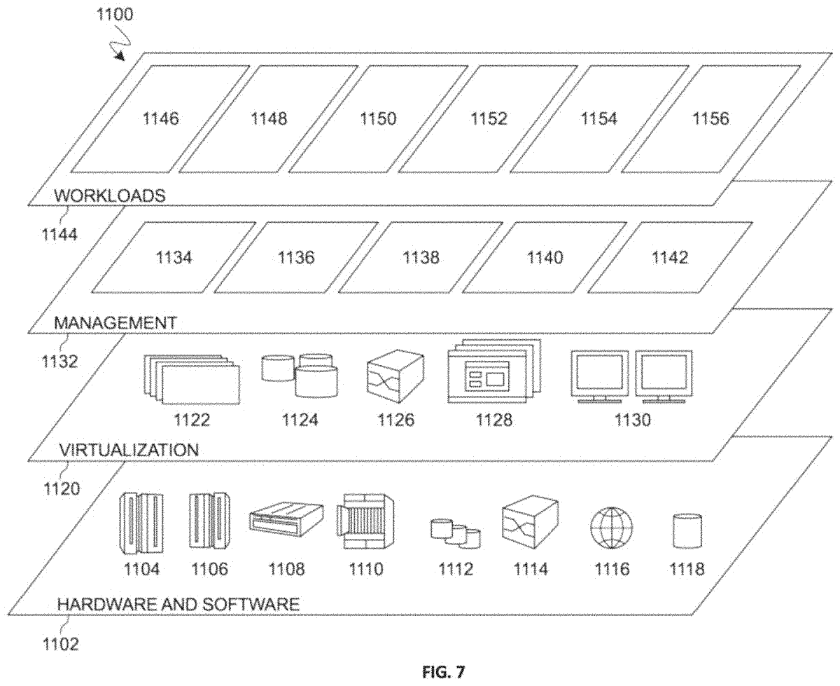

Referring now to FIG. 7, a set of functional abstraction layers 1100 provided by cloud computing environment 1000 is shown. It should be understood in advance that the components, layers, and functions shown in FIG. 7 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and product cycle management 1156. A PCM program 110a, 110b provides a way to transmit time-sensitive date information, for perishable products, from a manufacturer to consumers, by leveraging a retailer's inventory control system.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
storing, in an inventory database, a batch-related information for a corresponding batch of products, wherein the stored batch-related information includes a batch date assigned to the corresponding batch of products;
detecting a consumer identifier (ID) in a purchase transaction for a product of the corresponding batch of products;
recording the purchase transaction for the product with the detected consumer ID; and
transmitting, to a device associated with the detected consumer ID, the batch date linked to the product of the corresponding batch of products.

2. The method of claim 1, further comprising:
detecting the batch-related information for the corresponding batch of products encoded in a machine-readable code on a packaging of at least one product of the corresponding batch of products.

3. The method of claim 1, further comprising:
identifying, using the detected consumer ID, a consumer profile registered with a retailer-based loyalty program.

4. The method of claim 1, further comprising:
sensing, a machine-readable code on a packaging of the product in the purchase transaction; and
removing an instance of the product from a current stock stored in the inventory database.

5. The method of claim 2, wherein the machine-readable code is selected from a group consisting of: a GS1 DataMatrix code and a QR code.

6. The method of claim 1, further comprising:
encoding the batch date assigned to the corresponding batch of products in a QR code affixed to each product of the corresponding batch of products, wherein the encoded batch date includes an expiration date of each product of the corresponding batch of products.

7. The method of claim 6, further comprising:
in response to decoding the QR code affixed to a single product of the corresponding batch of products, determining the expiration date of each product of the corresponding batch of products.

8. A computer system for product cycle management, comprising:
one or more processors, one or more computer-readable memories, one or more computer-readable tangible storage media, and program instructions stored on at least one of the one or more computer-readable tangible storage media for execution by at least one of the one or more processors via at least one of the one or more memories, wherein the computer system is capable of performing a method comprising:
storing, in an inventory database, a batch-related information for a corresponding batch of products, wherein the stored batch-related information includes a batch date assigned to the corresponding batch of products;
detecting a consumer identifier (ID) in a purchase transaction for a product of the corresponding batch of products;
recording the purchase transaction for the product with the detected consumer ID; and
transmitting, to a device associated with the detected consumer ID, the batch date linked to the product of the corresponding batch of products.

9. The computer system of claim 8, further comprising:
detecting the batch-related information for the corresponding batch of products encoded in a machine-readable code on a packaging of at least one product of the corresponding batch of products.

10. The computer system of claim 8, further comprising:
identifying, using the detected consumer ID, a consumer profile registered with a retailer-based loyalty program.

11. The computer system of claim 8, further comprising:
sensing, a machine-readable code on a packaging of the product in the purchase transaction; and
removing an instance of the product from a current stock stored in the inventory database.

12. The computer system of claim 9, wherein the machine-readable code is selected from a group consisting of: a GS1 DataMatrix code and a QR code.

13. The computer system of claim 8, further comprising:
encoding the batch date assigned to the corresponding batch of products in a QR code affixed to each product of the corresponding batch of products, wherein the encoded batch date includes an expiration date of each product of the corresponding batch of products.

14. The computer system of claim 13, further comprising:
in response to decoding the QR code affixed to a single product of the corresponding batch of products, determining the expiration date of each product of the corresponding batch of products.

15. A computer program product for product cycle management, the computer program product comprising:
one or more computer-readable storage media and program instructions collectively stored on the one or more computer-readable storage media, the program instructions comprising:
program instructions to store, in an inventory database, a batch-related information for a corresponding batch of products, wherein the stored batch-related information includes a batch date assigned to the corresponding batch of products;
program instructions to detect a consumer identifier (ID) in a purchase transaction for a product of the corresponding batch of products;
program instructions to record the purchase transaction for the product with the detected consumer ID; and
program instructions to transmit, to a device associated with the detected consumer ID, the batch date linked to the product of the corresponding batch of products.

16. The computer program product of claim 15, further comprising:
program instructions to identify, using the detected consumer ID, a consumer profile registered with a retailer-based loyalty program.

17. The computer program product of claim 15, further comprising:
program instructions to sense, a machine-readable code on a packaging of the product in the purchase transaction; and
removing an instance of the product from a current stock stored in the inventory database.

18. The computer program product of claim 17, wherein the machine-readable code is selected from a group consisting of: a GS1 DataMatrix code and a QR code.

19. The computer program product of claim 15, further comprising:
program instructions to encode the batch date assigned to the corresponding batch of products in a QR code affixed to each product of the corresponding batch of products, wherein the encoded batch date includes an expiration date of each product of the corresponding batch of products.

20. The computer program product of claim 19, further comprising:
program instructions to in response to decoding the QR code affixed to a single product of the corresponding batch of products, determine the expiration date of each product of the corresponding batch of products.
